(19) United States
(12) Patent Application Publication
(10) Pub. No.: US 2020/0364380 A1
(43) Pub. Date: Nov. 19, 2020

(54) MODULAR BUILDING DESIGN AND DATA HANDLING SYSTEM

(71) Applicant: Robert J. Simmons, Hayward, CA (US)

(72) Inventor: Robert J. Simmons, Hayward, CA (US)

(21) Appl. No.: 16/716,415

(22) Filed: Dec. 16, 2019

Related U.S. Application Data
(63) Continuation of application No. 15/466,756, filed on Mar. 22, 2017, now abandoned.
(60) Provisional application No. 62/311,892, filed on Mar. 22, 2016.

(51) Int. Cl. G06F 30/13

(52) U.S. Cl. CPC G06F 30/13; G06F 2111/20

(57) ABSTRACT

A computer-implemented system and method of designing a building provides a set of graphically-depicted, selectable modular components for constructing a building design in a graphical user interface. Each modular component is a cuboidal representation of a category of building structures. Each modular component has one or more insertion points for connecting with an adjacent modular component.

### CROSS-REFERENCES

This application is a continuation of U.S. patent application Ser. No. 15/466,756 filed Mar. 22, 2017, which claims priority from U.S. Provisional Patent Application Ser. No. 62/311,892, filed Mar. 22, 2016. The complete disclosures of each application are hereby incorporated by reference in their entireties for all purposes.

The following related applications and materials are incorporated by reference, in their entireties, for all purposes: U.S. Pat. No. 8,453,414; U.S. Pat. No. 6,802,169; U.S. Pat. No. 7,941,985; and U.S. Pat. No. 7,051,917.

### FIELD

This disclosure relates to systems and methods for generating three-dimensional (3D) models in a graphical user interface.

### INTRODUCTION

Building and construction projects typically require complex design plans with highly repetitive structural components, and many associated specifications. Design plans can be time consuming to generate, and overly complex visually for many purposes.

There is a need for improved software tools that allow rapid configuration of highly detailed three dimensional content and modeling, which is easy to view and understand, while carrying potentially large amounts of data and information for many subsequent uses and different applications.

### SUMMARY

Modular building design and data handling systems according to the present teachings provide a simplified but powerful 3D modeling solution.

A computer-implemented system and method of designing a building provides a set of graphically-depicted, selectable modular components for constructing a building design in a graphical user interface. Each modular component is a cuboidal representation of a category of building structures, for example, columns, beams, ground supports. Each modular component has one or more insertion points for connecting with an adjacent modular component.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram showing an illustrative I-beam component, and various reference blocks.

FIG. 2 is an isometric view of an illustrative beam and supporting angle bracket, with corresponding reference block.

FIG. 3 is an isometric view of an illustrative I-beam and corresponding reference block.

FIG. 4 is an isometric view of physical components of an illustrative pipe rack.

FIG. 5 is a component-level reference block representation of the pipe rack of FIG. 4.

FIG. 6 is a pipe rack-level reference block representation of the pipe rack of FIG. 5.

FIG. 7 is a schematic diagram of an illustrative stairwell, showing various levels of reference blocks.

FIG. 8 is a schematic diagram of illustrative reference blocks corresponding to beams, a column, and a supportive foundation block.

FIG. 9 is a view of a portion of an illustrative building in the process of being modeled using reference blocks in accordance with aspects of the present disclosure.

FIG. 10 is a schematic diagram of an illustrative data processing system suitable for use with aspects of the present disclosure.

FIG. 11 is a schematic diagram of an illustrative distributed data processing system or network suitable for use with aspects of the present disclosure.

### DESCRIPTION

Various aspects and examples of a modular building design and data handling system, as well as related methods, are described below and illustrated in the associated drawings. Unless otherwise specified, a modular building design and data handling system as described herein, and/or its various components may, but are not required to, contain at least one of the structure, components, functionality, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

Definitions

The following definitions apply herein, unless otherwise indicated.

“Substantially” means to be essentially conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

A “reference block” is a three dimensional representation of a building component related to the nominal volumetric space filled by the component. A reference block may be any convex polyhedron having a shape corresponding to the general outer dimensions of a structural building component or group of components. A reference block may also be referred to as a spatial envelope corresponding generally to extent dimensions of a modular building component. For example, a spatial envelope may have a cuboidal shape corresponding generally to outer dimensions of a box column or an I-beam. A reference block or spatial envelope may function as a volumetric domicile for specifications, rules, or other data associated with the respective building component, or with one or more interfaces with adjacent reference blocks or a host wire frame

A reference block may also be thought of as a simplified digital domicile for a complex set of data that can precisely define manufacturing and operational requirements while still allowing easy arrangement, and maintaining integrity of interfaces with adjacent reference blocks. The reference block provides a visual vocabulary for piecing together data sets, where each data set represents a component or a modular grouping of components (or other modules).

An “insertion point” or “modular insertion point” is a reference point and interface on a reference block that can be used to establish locational, contextual, and/or compatibility-based relevance between one or more other reference blocks. For example, one or more insertion points may define connection relationships between beams and/or columns via moment-resistant or gravity catch joinder mechanisms as described in U.S. Pat. No. 8,453,414; U.S. Pat. No. 8,161,707; and U.S. Pat. No. 7,051,917, each of which is hereby incorporated by reference.

Overview

In general, a modular building design and data handling system in accordance with the present disclosure may include a software program presenting a graphical user interface (GUI) having a plurality of interactive elements for designing buildings and other architectural projects. As depicted in the drawings, these elements include reference blocks which represent building components or groups of components. The reference blocks can be hierarchically organized, such that reference blocks representing, for example, stairway components can be assembled into higher level reference blocks representing larger structures, such as a flight of stairs, which can be assembled into even higher level reference blocks, such as a complete stairwell. At each level, the reference block can function both as a spatial envelope representing the volumetric space taken up by the underlying object(s), and as a digital domicile for housing the data and rules associated with the underlying object(s). Furthermore, each reference block may include one or more visible indicia corresponding to modular insertion points. The modular insertion point can be used to establish locational relevance between one or more of the blocks, and may further represent a rule-based programmatic interface for linking with adjacent reference block(s). Additional description for each of these concepts is found below.

It should be appreciated that the principles and concepts disclosed and depicted herein may be applied outside the building and architecture fields (e.g., in the field of manufacturing). For example, the described design system may be used advantageously to generate three dimensional models of any product, structure, or apparatus which is formed of modular components.

In general, the systems and methods disclosed herein may be described as a set of visual tools for modeling a complex structure by modularizing both the physical nature and the informational nature (e.g., specifications, rules, knowledge, data) of the components available to create that complex structure. In so doing, the systems and methods of the present disclosure encapsulate information such that a user is empowered to generate a design without the need to know every detail of every component. Additionally, these systems and methods facilitate the parallel development of any number of components and modules associated with the structure. This is because a designer or engineer working on one such component need only be cognizant of the modular insertion point(s) for that component, while remaining free to modify or redesign other aspects of the component as needed. This remains true at every level of the hierarchy of modular reference blocks. Accordingly, once the relevant reference blocks and modular insertion points are established, individuals and teams associated with the design of a complex structure no longer need to operate in series. At the very least, such a need for sequential design work is greatly reduced.

Aspects of the modular building design and data handling system may be embodied as a computer method, computer system, or computer program product. Accordingly, aspects of the system may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the system may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of the system may be written in one or any combination of programming languages, including an object-oriented programming language such as Java, Smalltalk, C++, and/or the like, and conventional procedural programming languages, such as C. Mobile apps may be developed using any suitable language, including those previously mentioned, as well as Objective-C, Swift, C#, HTMLS, and the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the system are described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer-readable medium that can direct a computer, other programmable data processing apparatus, and/or other device to function in a particular manner, such that the instructions stored in the computer-readable medium produce an article of manufacture including instructions which implement the function/act specified in the flowchart and/or block diagram block or blocks.

The computer program instructions can also be loaded onto a computer, other programmable data processing apparatus, and/or other device to cause a series of operational steps to be performed on the device to produce a computer-implemented process such that the instructions which execute on the computer or other programmable apparatus provide processes for implementing the functions/acts specified in the flowchart and/or block diagram block or blocks.

Any flowchart and/or block diagram in the drawings is intended to illustrate the architecture, functionality, and/or operation of possible implementations of systems, methods, and computer program products according to aspects of the system. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

Examples, Components, and Alternatives

The following sections describe selected aspects of exemplary modular building design and data handling systems, as well as related systems and/or methods. The examples in these sections are intended for illustration and should not be interpreted as limiting the entire scope of the present disclosure. Each section may include one or more distinct embodiments or examples, and/or contextual or related information, function, and/or structure.

Reference Blocks and Design System

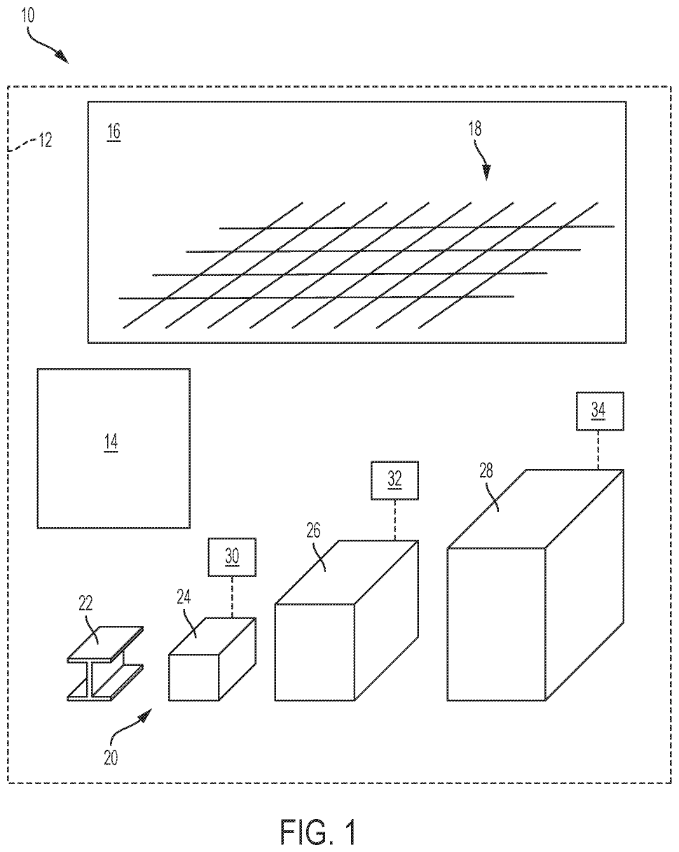

As shown in FIGS. 1-9, this section describes aspects of a modular building design and data handling system 10.

As depicted in FIG. 1, system 10 includes a graphical user interface (GUI) 12 having a menu 14 and a 3D construction space 16 including a base grid 18. Various modular, cuboidal reference blocks 20 are available for modeling a building. Additional reference blocks 20 may be provided and/or user-defined, such as by combining two or more component-level reference blocks into a larger modular block. This is shown in FIG. 1 by depicting a component 22 (in this example, an I-beam), a corresponding reference block 24, a multi-component reference block 26, and a larger reference block 28 made up of two or more blocks 26. Block 24 may be referred to as a “nano” block or nano cube (e.g., a beam or column), block 26 may be referred to as a micro block or micro cube (e.g., a room), and block 28 may be referred to as a “mini” block or mini cube (e.g., a group of rooms with an adjacent hallway). Any of these blocks 20 may be placed onto base grid 18 and joined with other blocks to model a building or other structure.

Each block 20 is sized and shaped to envelope the volumetric space of the component(s) represented by the block. Additionally, each block 20 includes a respective set of data 30, 32, 34 that precisely defines manufacturing and operational requirements, describes modes of possible arrangement with other reference blocks, and ensures integrity of interfaces with adjacent reference blocks is maintained. Data set 30, 32, 34 may be dynamically and automatically assembled, based on the component(s) and other block(s) included in any given reference block 20.

In some examples, any given block 20 may represent an encapsulation of information describing a category of components, both existing and hypothetical, any one of which might satisfy the description. In other words, the block may be a representation of any structure meeting the set of physical and informational criteria defined by the data and rules domiciled therein and having a specific, well-defined interface (i.e., modular insertion point). For example, a “beam” reference block may represent any beam meeting selected size, load-bearing, and weight limitations and configured to interface properly with a selected type or types of column. In this example, although the actual beam type may have a default value, whether the beam ends up as, e.g., an I-beam, J-beam, or box beam is inconsequential to the user, as those details can be developed independently.

Some of the data and rules encapsulated in blocks 20 may be variable or selectable dynamically. For example, certain optional features may be enhanced or limited, depending on the block(s) to which the present block is attached. This may result in an automatic cascading or domino effect, such that exchanging one reference block over another can have a ripple effect throughout the structure as each component automatically adjusts its feature set. This dynamic cascade is an automatic feature of system 10, although a user is alerted to the effects, as well as any conflicts created by the action (e.g., if a previously selected reference block can no longer function adequately, given the later design choice).

Menu 14 may include multiple reference blocks of different hierarchical levels, some or all of which may be organized in kits. For example, modular industrial structures may be organized in kits including a modular industrial structure, modular foundation system, module assembly system, modular pipe rack, modular access system, and modular design system.

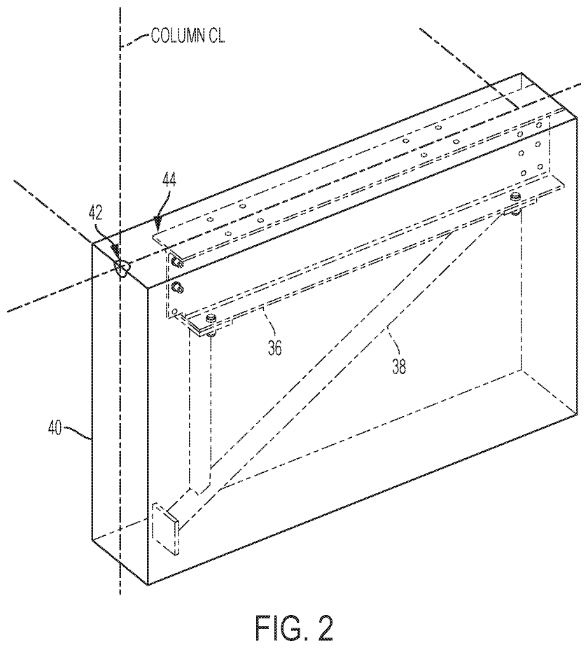

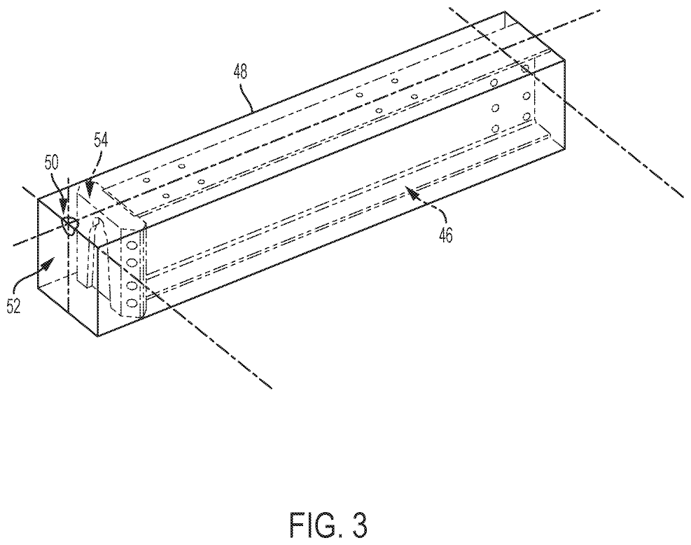

FIGS. 2 and 3 show specific examples of reference blocks and associated component structures. FIG. 2 depicts a structure known as an outrigger, which includes an I-beam 36 with an attached angle bracket support 38. The outrigger as a whole is represented by reference block 40. As shown in FIG. 1, reference block 40 is a spatial envelope surrounding the beam and bracket. Indicia 42 may be included to indicate where block 40 can interface with other reference blocks. Additional space is included around the underlying components. This may be done, for example, to ensure proper interfacing and spacing of the components within an overall structure. For example, indicia 42 may be spaced from an end 44 of beam 36. Indicia 42 indicates where the block would mate or otherwise connect with a building wire frame, as represented in this case by the centerline of a beam. In other words, blocks 20, such as block 40, may be assembled around a wire frame model. In the absence of a wire frame model, a wire frame may be assumed, such that connections between components can be consistently modeled as happening along axes and centerlines, rather than at component faces. Indicia 42 may represent and/or be referred to as an insertion point.

FIG. 3 depicts a cantilevered beam 46 virtually encapsulated by a reference block 48. Similar to block 40, block 48 includes an insertion point indicator 50. An end 52 of block 48 is spaced from a corresponding end 54 of beam 46 to account for reaching from end 54 to the wire frame.

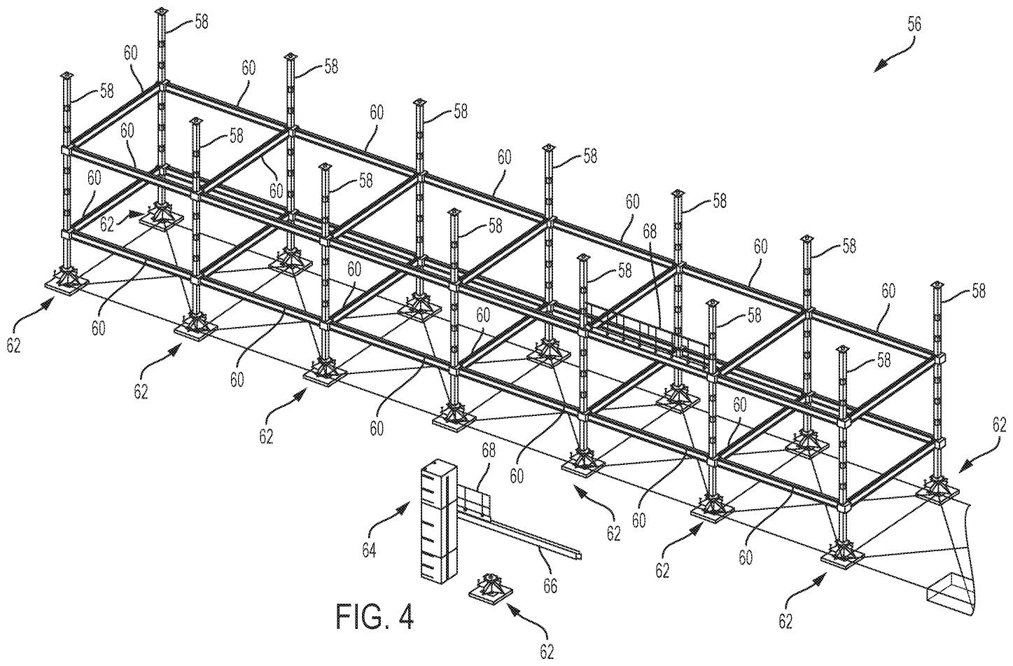

FIG. 4 depicts a structure known as a pipe rack 56. The physical components of pipe rack 56 are depicted in realistic fashion. For example, FIG. 4 shows vertical columns 58 and horizontal beams 60 forming a frame of the pipe rack. Columns 58 are supported on footing structures 62. An enclosed ladder 64, platform 66, and handrail 68 are depicted, with some of these components separated from the frame of the pipe rack for easier identification.

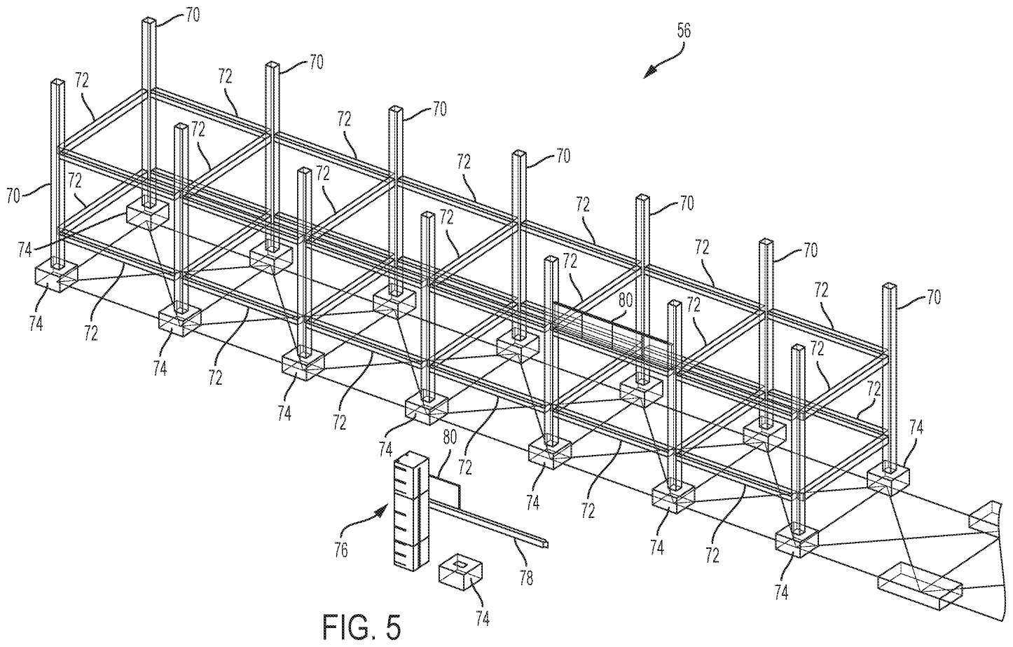

Turning to FIG. 5, pipe rack 56 is depicted as it would be modeled using system 10, with various reference blocks 20 modeling the various components. For example, as shown in FIG. 5, vertical columns 58 are modeled by column reference blocks 70.

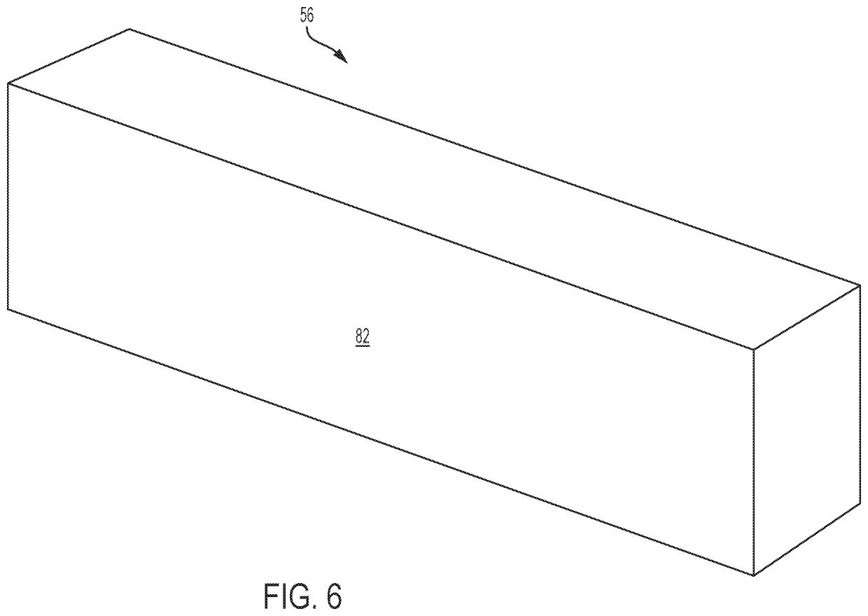

Similarly, horizontal beams 60 are modeled by beam reference blocks 72, and footing structures 62 are modeled by foundation reference blocks 74. Enclosed ladder 64 is modeled by enclosed ladder reference block 76, platform 66 by platform reference block 78, and handrail 68 by handrail reference block 80. FIG. 6 depicts pipe rack 56 as represented by a pipe rack-level reference block 82. Using multiple copies of block 82, a user can model a pipe rack system having any length and/or width.

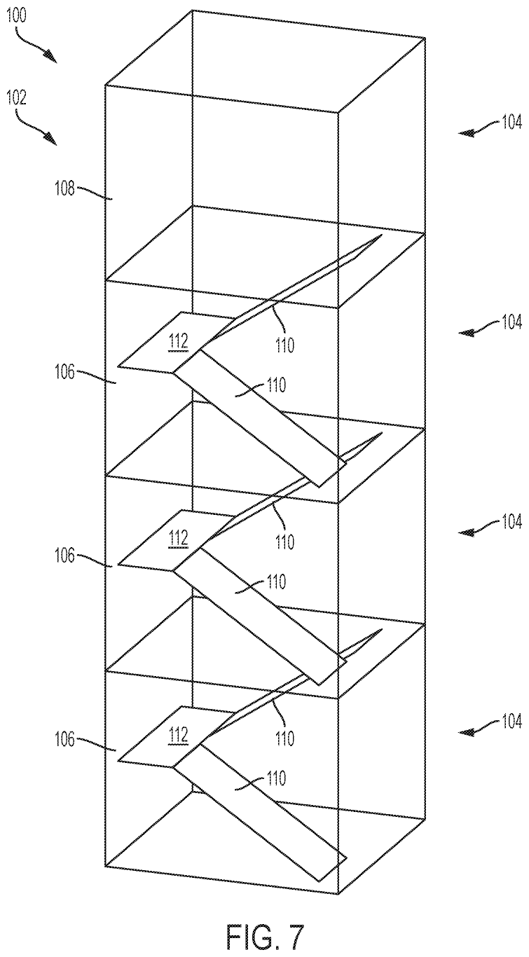

FIG. 7 depicts a stairwell 100 represented by a stairwell mini reference block 102. Block 102 includes multiple micro reference blocks 104, specifically three copies of a flight-of-stairs micro block 106 and one copy of a penthouse micro block 108. Each of the flight-of-stairs micro blocks 106 includes two string-of-steps nano blocks 110 and a landing nano block 112. Stairwell reference block 102 is an example of a vertical circulation structure (e.g., an elevator, stairs, etc.) that can be integrated into a building wire frame model.

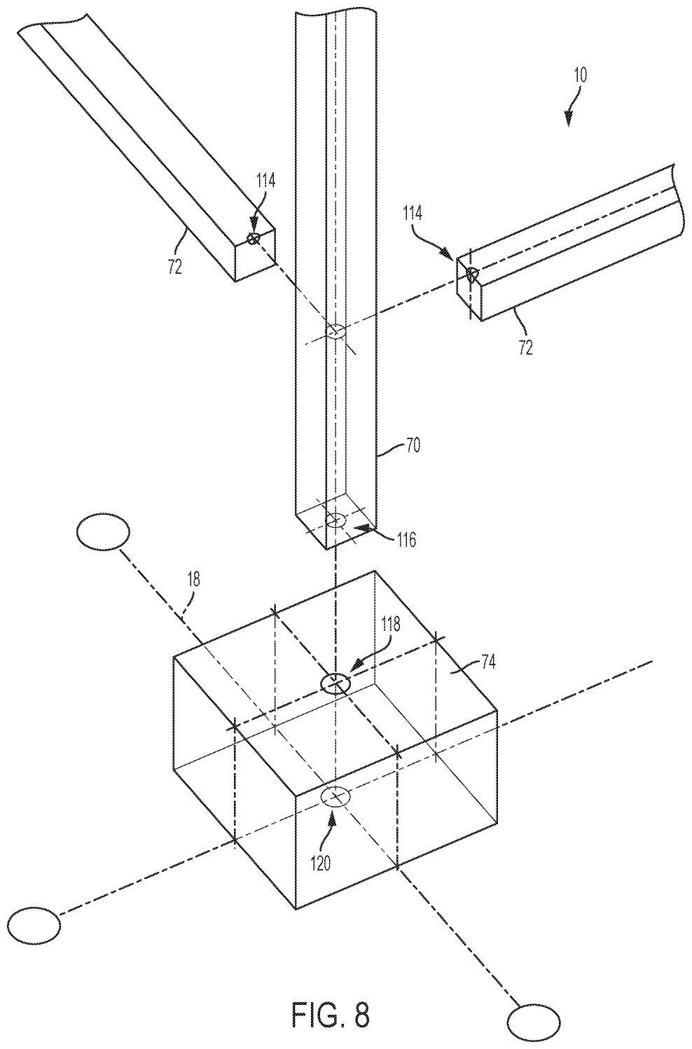

FIG. 8 is an exploded view of foundation reference block 74, column reference block 70, and beam reference blocks 72, showing how the various blocks are assembled and positioned via insertion points such as a modular beam insertion point 114, and a modular column insertion point 116, a foundation insertion point 118, and a foundation reference point 120 on grid 18.

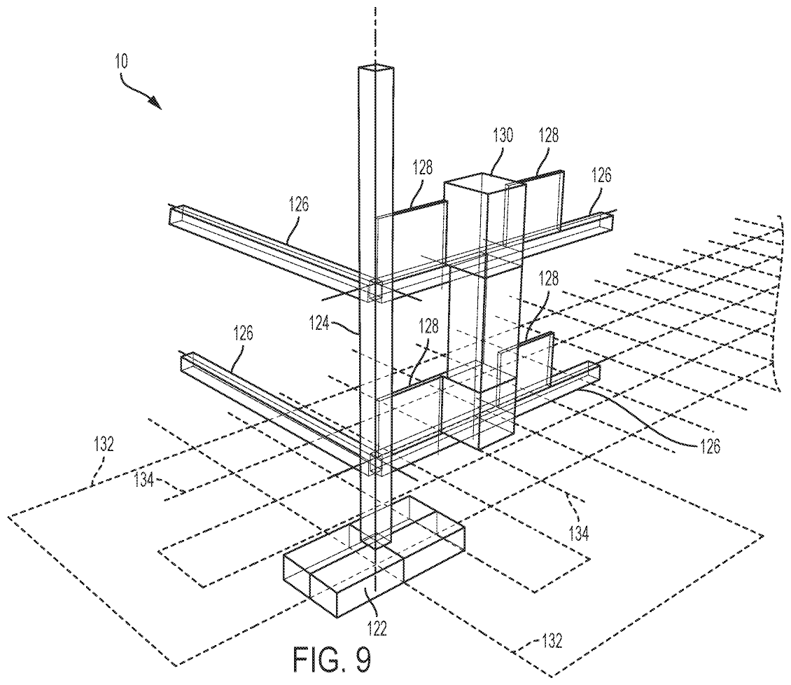

FIG. 9 depicts a ground assembly or foundation reference block 122 supporting a column reference block 124 and beam reference blocks 126. Handrail blocks 128 and a ladder module 130 are shown mounted into the wire frame structure. FIG. 9 also shows grid line components, including primary grid lines 132 and secondary grid lines 134.

Illustrative Data Processing System

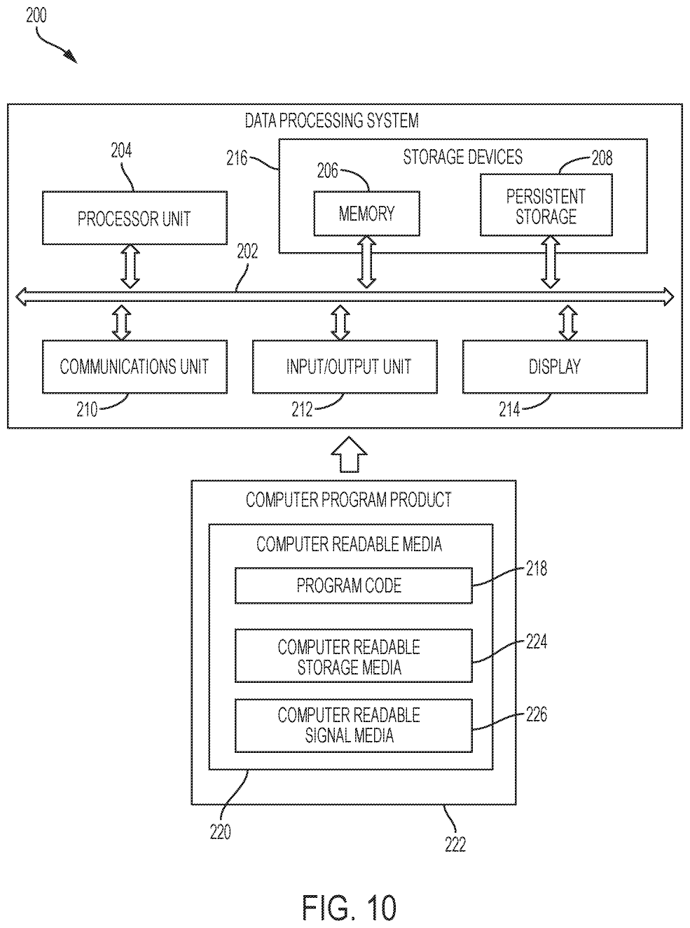

As shown in FIG. 10, this example describes a data processing system 200 (also referred to as a computer) in accordance with aspects of the present disclosure. In this example, data processing system 200 is an illustrative data processing system suitable for implementing aspects of a modular building design and data handling system according to the present disclosure. More specifically, in some examples, devices that are embodiments of data processing systems (e.g., smartphones, tablets, personal computers) may store and/or execute software embodying system 10 as described above.

In this illustrative example, data processing system 200 includes communications framework 202. Communications framework 202 provides communications between processor unit 204, memory 206, persistent storage 208, communications unit 210, input/output (I/O) unit 212, and display 214. Memory 206, persistent storage 208, communications unit 210, input/output (I/O) unit 212, and display 214 are examples of resources accessible by processor unit 204 via communications framework 202.

Processor unit 204 serves to run instructions that may be loaded into memory 206. Processor unit 204 may be a number of processors, a multi-processor core, or some other type of processor, depending on the particular implementation. Further, processor unit 204 may be implemented using a number of heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and other suitable information either on a temporary basis or a permanent basis.

Storage devices 216 also may be referred to as computer-readable storage devices in these examples. Memory 206, in these examples, may be, for example, a random access memory or any other suitable volatile or non-volatile storage device. Persistent storage 208 may take various forms, depending on the particular implementation.

For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output (I/O) unit 212 allows for input and output of data with other devices that may be connected to data processing system 200. For example, input/output (I/O) unit 212 may provide a connection for user input through a keyboard, a mouse, and/or some other suitable input device. Further, input/output (I/O) unit 212 may send output to a printer. Display 214 provides a mechanism to display information to a user.

Instructions for the operating system, applications, and/or programs may be located in storage devices 216, which are in communication with processor unit 204 through communications framework 202. In these illustrative examples, the instructions are in a functional form on persistent storage 208. These instructions may be loaded into memory 206 for execution by processor unit 204. The processes of the different embodiments may be performed by processor unit 204 using computer-implemented instructions, which may be located in a memory, such as memory 206.

These instructions are referred to as program instructions, program code, computer usable program code, or computer-readable program code that may be read and executed by a processor in processor unit 204. The program code in the different embodiments may be embodied on different physical or computer-readable storage media, such as memory 206 or persistent storage 208.

Program code 218 is located in a functional form on computer-readable media 220 that is selectively removable and may be loaded onto or transferred to data processing system 200 for execution by processor unit 204. Program code 218 and computer-readable media 220 form computer program product 222 in these examples. In one example, computer-readable media 220 may be computer-readable storage media 224 or computer-readable signal media 226.

Computer-readable storage media 224 may include, for example, an optical or magnetic disk that is inserted or placed into a drive or other device that is part of persistent storage 208 for transfer onto a storage device, such as a hard drive, that is part of persistent storage 208. Computer-readable storage media 224 also may take the form of a persistent storage, such as a hard drive, a thumb drive, or a flash memory, that is connected to data processing system 200. In some instances, computer-readable storage media 224 may not be removable from data processing system 200.

In these examples, computer-readable storage media 224 is a physical or tangible storage device used to store program code 218 rather than a medium that propagates or transmits program code 218. Computer-readable storage media 224 is also referred to as a computer-readable tangible storage device or a computer-readable physical storage device. In other words, computer-readable storage media 224 is a media that can be touched by a person.

Alternatively, program code 218 may be transferred to data processing system 200 using computer-readable signal media 226. Computer-readable signal media 226 may be, for example, a propagated data signal containing program code 218. For example, computer-readable signal media 226 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 218 may be downloaded over a network to persistent storage 208 from another device or data processing system through computer-readable signal media 226 for use within data processing system 200. For instance, program code stored in a computer-readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to and/or in place of those illustrated for data processing system 200. Other components shown in FIG. 10 can be varied from the illustrative examples shown. The different embodiments may be implemented using any hardware device or system capable of running program code. As one example, data processing system 200 may include organic components integrated with inorganic components and/or may be comprised entirely of organic components excluding a human being. For example, a storage device may be comprised of an organic semiconductor.

In another illustrative example, processor unit 204 may take the form of a hardware unit that has circuits that are manufactured or configured for a particular use. This type of hardware may perform operations without needing program code to be loaded into a memory from a storage device to be configured to perform the operations.

For example, when processor unit 204 takes the form of a hardware unit, processor unit 204 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a field programmable logic array, a field programmable gate array, and other suitable hardware devices. With this type of implementation, program code 218 may be omitted, because the processes for the different embodiments are implemented in a hardware unit.

In still another illustrative example, processor unit 204 may be implemented using a combination of processors found in computers and hardware units. Processor unit 204 may have a number of hardware units and a number of processors that are configured to run program code 218. With this depicted example, some of the processes may be implemented in the number of hardware units, while other processes may be implemented in the number of processors.

In another example, a bus system may be used to implement communications framework 202 and may be comprised of one or more buses, such as a system bus or an input/output bus. Of course, the bus system may be implemented using any suitable type of architecture that provides for a transfer of data between different components or devices attached to the bus system.

Additionally, communications unit 210 may include a number of devices that transmit data, receive data, or both transmit and receive data. Communications unit 210 may be, for example, a modem or a network adapter, two network adapters, or some combination thereof. Further, a memory may be, for example, memory 206, or a cache, such as that found in an interface and memory controller hub that may be present in communications framework 202.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the drawings. For example, the functions of two blocks shown in succession may be executed substantially concurrently, or the functions of the blocks may sometimes be executed in the reverse order, depending upon the functionality involved.

Illustrative Distributed Data Processing System

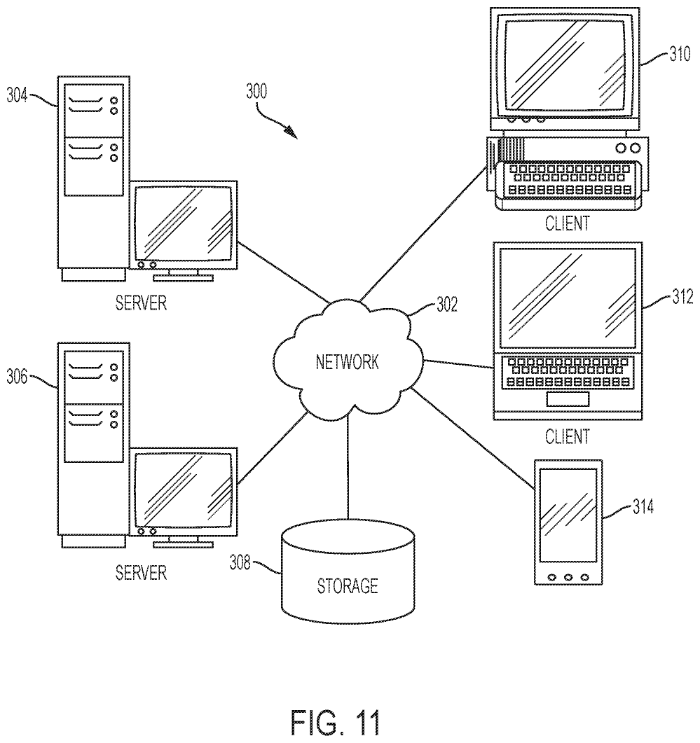

As shown in FIG. 11, this example describes a general network data processing system 300, interchangeably termed a network, a computer network, a network system, a distributed data processing system, or a distributed network, aspects of which may be included in one or more illustrative embodiments of a modular building design and data handling system according to the present teachings. For example, data and software instructions may be communicated, executed, and/or stored in one or more components of system 300.

It should be appreciated that FIG. 11 is provided as an illustration of one implementation and is not intended to imply any limitation with regard to environments in which different embodiments may be implemented. Many modifications to the depicted environment may be made.

Network data processing system 300 is a network of computers, each of which is an example of data processing system 200, and other components. Network data processing system 300 may include network 302, which is a medium configured to provide communications links between various devices and computers connected together within network data processing system 300. Network 302 may include connections such as wired or wireless communication links, fiber optic cables, and/or any other suitable medium for transmitting and/or communicating data between network devices, or any combination thereof.

In the depicted example, a first network device 304 and a second network device 306 connect to network 302, as does an electronic storage device 308. Network devices 304 and 306 are each examples of data processing system 200, described above. In the depicted example, devices 304 and 306 are shown as server computers. However, network devices may include, without limitation, one or more personal computers, mobile computing devices such as personal digital assistants (PDAs), tablets, and smart phones, handheld gaming devices, wearable devices, tablet computers, routers, switches, voice gates, servers, electronic storage devices, imaging devices, and/or other networked-enabled tools that may perform a mechanical or other function. These network devices may be interconnected through wired, wireless, optical, and other appropriate communication links.

In addition, client electronic devices, such as a client computer 310, a client laptop or tablet 312, and/or a client smart device 314, may connect to network 302. Each of these devices is an example of data processing system 200, described above regarding FIG. 10. Client electronic devices 310, 312, and 314 may include, for example, one or more personal computers, network computers, and/or mobile computing devices such as personal digital assistants (PDAs), smart phones, handheld gaming devices, wearable devices, and/or tablet computers, and the like. In the depicted example, server 304 provides information, such as boot files, operating system images, and applications to one or more of client electronic devices 310, 312, and 314. Client electronic devices 310, 312, and 314 may be referred to as “clients” with respect to a server such as server computer 304. Network data processing system 300 may include more or fewer servers and clients or no servers or clients, as well as other devices not shown.

Client smart device 314 may include any suitable portable electronic device capable of wireless communications and execution of software, such as a smartphone or a tablet. Generally speaking, the term “smartphone” may describe any suitable portable electronic device having more advanced computing ability and network connectivity than a typical mobile phone. In addition to making phone calls (e.g., over a cellular network), smartphones may be capable of sending and receiving emails, texts, and multimedia messages, accessing the Internet, and/or functioning as a web browser. smart devices (e.g., smartphones) may also include features of other known electronic devices, such as a media player, personal digital assistant, digital camera, video camera, and/or global positioning system. smart devices (e.g., smartphones) may be capable of connecting with other smart devices, computers, or electronic devices wirelessly, such as through near field communications (NFC), BLUETOOTH®, WiFi, or mobile broadband networks. Wireless connectively may be established among smart devices, smartphones, computers, and other devices to form a mobile network where information can be exchanged.

Program code located in system 300 may be stored in or on a computer recordable storage medium, such as persistent storage 208 described above, and may be downloaded to a data processing system or other device for use. For example, program code may be stored on a computer recordable storage medium on server computer 304 and downloaded for use to client 310 over network 302 for use on client 310.

Network data processing system 300 may be implemented as one or more of a number of different types of networks. For example, system 300 may include an intranet, a local area network (LAN), a wide area network (WAN), or a personal area network (PAN). In some examples, network data processing system 300 includes the Internet, with network 302 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational and other computer systems may be utilized to route data and messages. In some examples, network 300 may be referred to as a “cloud.” In those examples, each server 304 may be referred to as a cloud computing node, and client electronic devices may be referred to as cloud consumers, or the like. FIG. 11 is intended as an example, and not as an architectural limitation for any illustrative embodiments.

Additional Examples and Illustrative Combinations

This section describes additional aspects and features of [INVENTION], presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. A method for modeling a design for a building, comprising

providing a set of selectable modular components for constructing a wire frame building design in a graphical user interface,

selecting a first modular building component from the set, generating a first spatial envelope for the selected first modular building component, the first spatial envelope having a three-dimensional convex polyhedron shape corresponding generally to extent dimensions of the first modular building component, and placing the associated first spatial envelope on a building site grid in a graphical user interface,

selecting a second modular building component from the set, generating a second spatial envelope for the selected second modular building component, the second spatial envelope having a three-dimensional convex polyhedron shape corresponding generally to extent dimensions of the second modular building component, and connecting the first spatial envelope with the second spatial envelope on the building site grid in the graphical user interface.

A1. The method of A0, wherein each of the first and second spatial envelopes has at least one insertion point for properly orienting the spatial envelope relative to one or more adjacent spatial envelopes.

A2. The method of A1, further comprising selecting an insertion point on the first spatial envelope to define a connection location and orientation for the second spatial envelope.

A3. The method of A0, wherein each spatial envelope has a cuboidal shape.

A4. The method of A0, wherein each spatial envelope is linked to a data package including information relating to the respective modular component, said information being accessible through the graphical user interface.

A5. The method of A4, wherein the data package includes at least one or more of the following: (a) dimensional specifications, (b) cost to produce, (c) cost to deliver, (d) retail price, (e) cost to assemble, (f) labor to assemble, (g) delivery time, (h) load limitations, (i) shipping limitations, (j) packaging requirements, and/or any other relevant characteristics or features of the spatial envelope.

A6. The method of A0, wherein each of the first and second modular building components includes one of the following: (a) a box column, (b) an I-beam, (c) a ladder structure, (d) stairs (vertical circulator) or stair enclosure, (e) an elevator shaft, (f) a ground assembly stand, (g) exterior envelope, (h) parapets, (i) mechanical modules, (j) shaft assemblies, (k) rooms for exams, treatment, offices, or bathrooms, and/or any other building feature or component.

B0. A method of generating a three-dimensional model in a graphical user interface, comprising

providing a kit of modular components, each component having one or more insertion points for determining locational relevance to one or more adjacent components, and assembling two or more of the modular components into a three-dimensional model.

B1. The method of B0, wherein the kit is configured to design a wire frame building structure.

B2. The method of B0, wherein the kit is configured to assemble rooms in relation to a wire frame chassis.

B3. The method of B0, wherein the kit is configured to design any structure including redundant modular components.

C0. A computer-implemented method of designing a building, the method comprising:

(a) providing a set of graphically-depicted, selectable modular components for constructing a building design in a graphical user interface (GUI), each modular component being a cuboidal representation of a category of building structures and having one or more insertion points for orienting the modular component to an adjacent component, each modular component having a data packet including specifications of the building structure;

(b) selecting a first modular component from the set, the first modular component having a first insertion point, and placing the first modular component into a three dimensional grid on the GUI; and

(c) selecting a second modular component from the set, the second modular component having a second insertion point, and placing the second modular component into adjacent proximity to the first modular component, including matching the first and second insertion points.

C1. The method of C0, wherein the data packet of the first modular component specifies that the respective building structure is a box column.

C2. The method of C0, wherein the data packet of the second modular component specifies that the respective building structure is an I-beam.

C3. The method of C0, wherein the data packet of the first modular component specifies a rule limitation that must be satisfied by a parametric specification contained in the data packet of the second data packet.

C4. The method of C0, further comprising:

in parallel, further designing the building structures represented by the first and second modular components.

C5. The method of C0, wherein the first modular component contains multiple other modular building components.

C6. The method of C5, wherein the first modular component represents a room.

C7. The method of C5, wherein the first modular component represents a stairway.

C8. The method of C0, wherein each modular building component has a first mode in which information in the respective data packet can be changed, and a second mode in which information in the respective data packet is fixed.

C9. The method of C0, wherein the data packet associated with the first modular component includes rules based on seismic specifications.

C10. The method of C0, wherein the data packet associated with the first modular component includes information specifying an allowable connection mechanism between the first and second modular building components.

C11. The method of C0, further comprising:

verifying that data in the packet associated with the first modular component is compatible with data in the packet associated with the second modular component.

C12. The method of C0, wherein the first data packet contains a fixed data set and a modifiable data set.

C13. The method of C0, further comprising:

copying and pasting the first and second modular building components into another location on the grid after the matching step.

C14. The method of C0, further comprising:

repeating steps (a), (b), and (c) to generate a first pipe rack module.

C15. The method of C14, further comprising:

generating a third modular component representing the pipe rack module.

C16. The method of C15, further comprising:

copying and pasting the third modular component to make an extended pipe rack model on the GUI.

C17. The method of C0, wherein information in the first data packet specifies a full moment connection mechanism between the building structures represented by the first and second modular components.

C18. The method of C0, wherein information in the first data packet specifies a gravity catch connection mechanism between the building structures represented by the first and second modular components.

C19. The method of C0, wherein matching may mean that insertion points of adjacent components are aligned, coincident, proximate, coordinated, overlapping, or in contact.

C20. The method of C0, wherein at least one of the modular components is a cuboidal representation of a non-cuboidal building structure.

D0. A building design software system, comprising:

(a) a set of graphically-depicted, selectable modular components for constructing a building design in a graphical user interface (GUI), each modular component being a cuboidal representation of a category of building structures and having one or more insertion points for orienting the modular component to an adjacent component, each modular component having a data packet including specifications of the building structure;

(b) a first modular component from the set, the first modular component having a first insertion point, the first modular component being placed into a three dimensional grid on the GUI, and

(c) a second modular component from the set, the second modular component having a second insertion point, the second modular component being placed into adjacent proximity to the first modular component, the first and second insertion points being matched.

Advantages, Features, Benefits

The different embodiments and examples of the modular building design and data handling system described herein provide several advantages over known solutions. For example, illustrative embodiments and examples described herein facilitate the visual presentation of multiple levels of data in a contextually relevant environment.

Furthermore, embodiments and examples described herein may enable the maintenance of the precise geometric relationship of adjacent data sets to allow compartmentalization/encapsulation of data creation and data management, while preserving the necessary relationship with adjacent data sets.

Furthermore, embodiments and examples described herein may provide an efficient parametric “vocabulary” (i.e., visual blocks), which allows all digital content to be authored and behave predictably relative to adjacent data sets.

Conclusion

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

What is claimed is:

1. A computer-implemented method of designing a building, the method comprising:
(a) providing a set of graphically-depicted, selectable modular components for constructing a building design in a graphical user interface (GUI), each modular component being a cuboidal representation of a category of building structures and having one or more insertion points for orienting the modular component to an adjacent component, each modular component having a data packet including specifications of the building structure;
(b) providing a user-selectable first modular component of the set, the first modular component having a first insertion point, and, in response to a first user action, placing the first modular component into a three dimensional grid on the GUI; and
(c) providing a user-selectable second modular component of the set, the second modular component having a second insertion point, and, in response to a second user action, placing the second modular component into adjacent proximity to the first modular component, including matching the first and second insertion points.

2. The method of claim 1, wherein the data packet of the first modular component specifies that the respective building structure is a box column.

3. The method of claim 1, wherein the data packet of the second modular component specifies that the respective building structure is an I-beam.

4. The method of claim 1, wherein the data packet of the first modular component specifies a rule limitation that must be satisfied by a parametric specification contained in the data packet of the second data packet.

5. The method of claim 1, further comprising:
in parallel, further designing the building structures represented by the first and second modular components.

6. The method of claim 1, wherein the first modular component contains multiple other modular building components. The method of claim 6, wherein the first modular component represents a room.

8. The method of claim 6, wherein the first modular component represents a stairway.

9. The method of claim 1, wherein each modular building component has a first mode in which information in the respective data packet can be changed, and a second mode in which information in the respective data packet is fixed.

10. The method of claim 1, wherein the data packet associated with the first modular component includes rules based on seismic specifications.

11. The method of claim 1, wherein the data packet associated with the first modular component includes information specifying an allowable connection mechanism between the first and second modular building components.

12. The method of claim 1, further comprising:
verifying that data in the packet associated with the first modular component is compatible with data in the packet associated with the second modular component.

13. The method of claim 1, wherein the first data packet contains a fixed data set and a modifiable data set.

14. The method of claim 1, further comprising:
in response to a third user action, copying and pasting the first and second modular building components into another location on the grid after the matching step.

15. The method of claim 1, further comprising:
repeating steps (a), (b), and (c) to generate a first pipe rack module.

16. The method of claim 15, further comprising:
generating a third modular component representing the pipe rack module.

17. The method of claim 16, further comprising:
in response to a fourth user action, copying and pasting the third modular component to make an extended pipe rack model on the GUI.

18. The method of claim 1, wherein information in the first data packet specifies a full moment connection mechanism between the building structures represented by the first and second modular components.

19. The method of claim 1, wherein information in the first data packet specifies a gravity catch connection mechanism between the building structures represented by the first and second modular components.

20. A building design software system, comprising:
(a) a set of graphically-depicted, selectable modular components for constructing a building design in a graphical user interface (GUI), each modular component being a cuboidal representation of a category of building structures and having one or more insertion points for orienting the modular component to an adjacent component, each modular component having a data packet including specifications of the building structure;
(b) a first modular component from the set, the first modular component having a first insertion point, the first modular component being placed into a three dimensional grid on the GUI, and
(c) a second modular component from the set, the second modular component having a second insertion point, the second modular component being placed into adjacent proximity to the first modular component, the first and second insertion points being matched.
